(19) United States
(12) Patent Application Publication
(10) Pub. No.: US 2003/0103641 A1
(43) Pub. Date: Jun. 5, 2003

(54) DEVICE FOR SOUND CONVERSION

(76) Inventor: STEFAN MARTEN, WEDEMARK (DE)

Correspondence Address: ALTERA LAW GROUP, LLC, 6500 CITY WEST PARKWAY, SUITE 100, MINNEAPOLIS, MN, 55344-7704, US

(21) Appl. No.: 09/400,241

(22) Filed: Sep. 21, 1999

(30) Foreign Application Priority Data
Sep. 24, 1998 (DE) 198 43 731.5-3

(51) Int. Cl. H04R 1/02

(52) U.S. Cl. 381/386

(57) ABSTRACT

A device is described for sound conversion with a sound transducer (3) and a printed circuit board (7) for carrying the electrical components (27) and contacts. The special feature of the invention consists in the fact that the printed circuit board (7) forms an acoustic component for influencing the acoustic properties of the sound converter (3).

The invention concerns a device for sound conversion with a sound transducer and a printed circuit board for carrying the electrical components and contacts.

Devices of this type are known in which a transducer, e.g., a microphone or a reproducer (speaker), requires for control an electronic circuit, which, mounted on a printed circuit board, forms a part of the device.

A first group of such devices forms wireless earphones in which, in particular, a HF-(high frequency) or infrared receiver device as well as an amplifier device are arranged in the direct vicinity of the reproducer. With earphones for active noise abatement likewise necessary are a reproducer as well as a sensing microphone and control electronics for regulating a sound signal that is to be reproduced. In this case for active noise abatement one also attempts to fit the control electronics along with the sound transducer into the earphones.

A second group of such devices is designed with wireless microphones, whereby a sound transducer, in this case a microphone, in particular is combined with a microphone amplifier device and a HF- or infrared transmitter device.

With the known devices the acoustic properties of the reproducer or the microphone are purposely influenced by, for example, the form of construction or by an appropriately formed housing in which the transducer is arranged. Through an appropriate housing, for example, the effective direction or transmission range of a microphone or a reproducer can be predetermined or influenced.

With such devices for sound conversion, besides the transfer quality above all small dimensions and low weight are required. This, in particular, thus represents a difficult to fulfill requirement since, besides the acoustically matched sound transducer, the control electronics and the necessary contacts between the transducer and the control electronics must be fitted in. Besides that, the assembly, where frequently fine wire contacts must be placed between the transducer and the control electronics, can be automated only in a very complicated manner. This additional assembly expense detrimentally increases the production time and costs.

The task of the present invention is therefore to make available an easily assembled device for sound conversion, which exhibits a comparably simple construction.

With the device of the type mentioned in the introduction the task is solved according to the invention by having the printed circuit board form an acoustic component that influences the acoustic properties of the sound transducer.

The advantages of the invention lie in particular in the fact that additional housing parts necessary for influencing the effective direction and/or the transmission range of a sound transducer are economized and thus an essential reduction of the size of the device is accomplished. Furthermore, a more rapid and cost-effective assembly of the device is achieved, since after the fitting together of the sound transducer and the control electronics electrical and acoustic components of the device exist as a single easily handled part. Thus already at a very early point in time in the course of assembly, before final assembly for example in an earphone, a testing of the acoustical and electrical components of the device is possible.

With a preferred implementation of the device, where the sound transducer exhibits an acoustic aperture for reception or transmission of sound waves, the printed circuit board is arranged in front of the acoustic aperture of the sound transducer and a corresponding printed circuit board section covering the acoustical aperture exhibits at least one opening. A reception or transmission of sound waves thus takes place through the opening provided in the corresponding section of the printed circuit board. In an expedient further development provision is made for several openings in the appropriate section of the printed circuit board.

The acoustical properties of the transducer can be influenced especially by changing the cross-sectional area of the opening, the thickness of the printed circuit board and the volume between the printed circuit board and the sound transducer. It is particularly advantageous to have the device designed in such a manner that the printed circuit board section covering the acoustic aperture and exhibiting at least one opening, together with the hollow space formed between the sound transducer and the printed circuit board form a resonator. Through an appropriate matching of the resonant frequency of the resonator the intended transfer characteristics and phase behavior of the device for sound conversion can be predetermined.

In an expedient further development of the device the opening is covered with an acoustic dampening material. The acoustic dampening material can be, for example, silk or fleece and is preferably glued to the surface of the printed circuit board facing the sound transducer. It is nevertheless likewise possible to stretch the acoustic dampening material over the opening or to clamp it between the printed circuit board and a surrounding housing.

The acoustic properties can be further influenced through the acoustic dampening material arranged before the opening. Thus it is possible, for example, to preferentially dampen resonance peaks of the resonator formed between the sound transducer and the printed circuit board. Beyond that, the frequency response characteristic of the device can likewise be influenced through suitable acoustic dampening material.

In a preferred implementation form an acoustic channel is arranged in an extension at the opening. By changing the length of the acoustic channel the resonant frequency of the resonator formed between the sound transducer and the printed circuit board can be tuned in an advantageous way over a wide range. In an expedient further development the acoustic channel exhibits a cross-sectional area increasing outward, through which especially the directional pattern of the sound transducer can be predetermined.

It is especially advantageous to have the sound transducer connected mechanically, in particular interlocked or through friction, with the printed circuit board. Here the sound transducer can be welded, glued or screwed to the printed circuit board. Alternatively, it is possible that a locking element provided for on the transducer can engage a corresponding opening in the printed circuit board and form an abutment so that the acoustic transducer is connected to the printed circuit board by means of a snap connection.

It is especially advantageous to have an air-tight connection between the acoustic transducer and the printed circuit board in order to ensure that between the transducer and the printed circuit board no acoustic energy escapes in an uncontrolled manner. For this, provision can be made for insulating material either on the sound transducer or on the printed circuit board, or the sound transducer is welded or glued to the printed circuit board.

In a further preferred implementation form the sound transducer is connected to the contacts of the printed circuit board especially through a solder or plug-in connection. Such connections simplify the mounting of the sound transducer to the printed circuit board since with a mechanical connection an electrical connection can be simultaneously realized.

With the sound transducer in the device it can be a matter of either a reproducer (speaker) or a microphone. According to the invention it is naturally also possible to place on the printed circuit board a microphone as well as a reproducer.

Advantageous further developments of the invention are characterized through the features of the dependent claims. In the following the invention will be further detailed by example with the aid of the drawing.

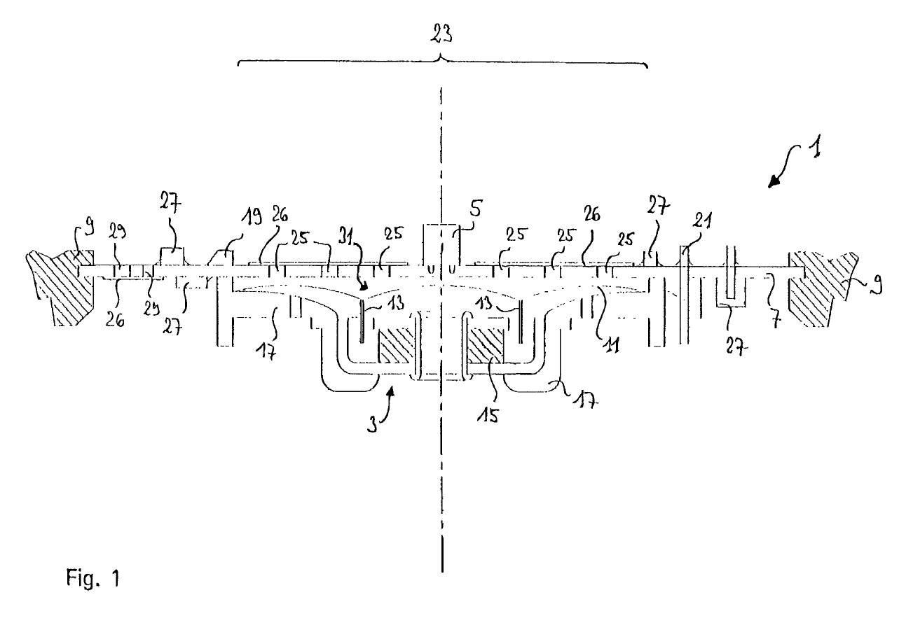

FIG. 1 shows a cross-section through a device for sound conversion according to the invention.

FIG. 1 shows a cross-section through a section of an earphone for active noise abatement. Represented is a loudspeaker 3 serving as a reproducer, a microphone 5 for picking up the sound signal necessary for the regulation, a printed circuit board 7 and housing sections 9.

The loudspeaker comprises a membrane 11, which is connected to a moving coil 13, a magnet 15 with an air gap, in which the moving coil 13 is at least partially arranged, and a converter housing 17, which carries the membrane 11 and the magnet 15. The converter housing 17 in turn comprises a locking extension 19 and a converter contact 21. The locking extension 19 is designed so that it projects through a corresponding opening in the printed circuit board 7 and forms a counter support with the printed circuit board 7. The converter contact 21 is electrically connected on the one hand to the moving coil 13 and on the other hand to the appropriate contact on the printed circuit board 7.

The printed circuit board 7 is attached on both sides to the housing sections 9, since it engages the represented recess in the corresponding housing sections 9. However, the fastening can also take place, for example, through screwing or gluing. The loudspeaker 3 is arranged with its sound opening for emitting sound waves directly on the surface of the printed circuit board 7 and is fastened with the aid of the locking extensions 19. The locking extensions 19 can likewise be clamped into the printed circuit board or can be glued to it. The loudspeaker 3 is electrically connected to the printed circuit board 7 by means of contacts 21, whereby the contacts 21 can additionally serve as fasting elements. Arranged in the section of the printed circuit board section 23 that covers the sound aperture of the loudspeaker 3 are first openings 25 for influencing the acoustic properties of the loudspeaker 3. On the side of the printed circuit board 7 opposite or facing the loudspeaker 3 is fastened an acoustic dampening material 26, for example silk or fleece, so that the first openings 25 are covered. These openings 25 can as a minimum also be left partially uncovered.

Arranged centrally on the printed circuit board section 23 is the microphone 5. In the edge region of the printed circuit board section 23 and on the remaining sections of the printed circuit board 7 provisions are made for electrical components 27. Furthermore, the printed circuit board 7 shows second openings 29 that likewise can be covered at least partially by an acoustic dampening material 28.

The section 23 of the printed circuit board that covers the sound aperture and that exhibits the first openings 25 together with the hollow space 31 between the membrane 11 of the loudspeaker 3 and the printed circuit board section 23 forms a resonator. Here the acoustic behavior of the resonator can be essentially influenced by changes in the size of the hollow space 31, the cross-sectional area of the first openings 25 and the thickness of the printed circuit board 7. Beyond that, a further tuning of the acoustical properties is possible through the acoustic dampening material 26 that is arranged in front of the first openings 25.

1. Device (1) for sound conversion with a sound transducer (3) and a printed circuit board (7) for carrying electrical components (27) and contacts, characterized by the fact that the printed circuit board (7) forms an acoustic component for influencing the acoustic properties of the sound transducer (3).

2. Device according to claim 1 where the sound transducer exhibits an aperture for picking up or emitting sound waves, characterized by the fact that the printed circuit board (7) is arranged in front of the sound aperture of the sound transducer (3) and a corresponding printed circuit board section (23) that covers the sound aperture exhibits at least one opening.

3. Device according to claim 2, designed so that the printed circuit board section (23) that covers the sound aperture and that exhibits an opening, together with the hollow space (31) formed between the sound transducer (3) and the printed circuit board section (23) forms a resonator.

4. Device according to claim 2 or 3, characterized by the fact that the opening is covered with an acoustic dampening material (26).

5. Device according to claim 2 through 4, characterized by the fact that a sound channel is arranged in an elongation at the opening.

6. Device according to claim 5, characterized by the fact that the cross-sectional area of the sound channel changes in its longitudinal direction.

7. Device according to claim 6, characterized by the fact that cross-sectional area of the sound channel increases toward its open end.

8. Device according to one of the preceding claims, characterized by the fact that the sound transducer (3) exhibits a locking element (19) that connects the sound transducer (3) mechanically, in particular in an interlocking manner, to the printed circuit board (7).

9. Device according to one of the claims 1 through 7, characterized by the fact that the sound transducer (3) is connected mechanically, in particular in an interlocking manner, to the printed circuit board (7).

10. Device according to one of the preceding claims, characterized by the fact that an essentially air-tight connection exists between the sound transducer (3) and the printed circuit board (7).

11. Device according to one of the preceding claims, characterized by the fact that the sound transducer (3) is electrically connected with the contacts of the printed circuit board (7).

12. Device according to one of the preceding claims, characterized by the fact that the sound transducer (3) is designed as a reproducer.

13. Device according to one of the claims 1 through 11, characterized by the fact that the sound transducer (3) is designed as a microphone or a microphone capsule.

14. Microphone with a device (1) for sound conversion according to claim 13.

15. Earphone with a device (1) for sound conversion according to one of the preceding claims.
